(19) United States
(12) Patent Application Publication
(10) Pub. No.: US 2026/0330347 A1
(43) Pub. Date: Oct. 22, 2026

(54) SYSTEM AND METHOD FOR AUTOMATED DYNAMIC USER INTERFACE AND INTEGRATED DIGITAL SKILLS TRAINING AND CONFIDENCE

(71) Applicant: Lisa Reubel, Flagler Beach, FL (US)

(72) Inventor: Lisa Reubel, Flagler Beach, FL (US)

(21) Appl. No.: 19/540,703

(22) Filed: Feb. 15, 2026

Related U.S. Application Data
(60) Provisional application No. 63/792,544, filed on Apr. 22, 2025.
(60) Provisional application No. 63/792,764, filed on Apr. 22, 2025.
(60) Provisional application No. 63/794,296, filed on Apr. 24, 2025.
(60) Provisional application No. 63/795,448, filed on Apr. 27, 2025.

(51) Int. Cl. G06Q 10/0631; G06F 9/451

(52) U.S. Cl. CPC G06Q 10/063112; G06F 9/451

(57) ABSTRACT

An AI-powered life navigator platform for providing modular, multi-tenant ecosystem of life assistance modules for seniors, veterans, individuals with disabilities, busy adults, teens, caregivers, and organizations. The platform comprises a navigator engine which includes a user profile store, a tenant configuration store, a module registry, an AI inference engine, a dynamic user interface orchestration engine, and a digital skills training and confidence system (DSTCS) overlay, wherein the AI inference engine receives interaction telemetry, including touch patterns and navigation events, and generates skill inferences such as digital skill level, motor stability, and nail-tap likelihood and the dynamic user interface orchestration engine automatically and dynamically changes user interfaces based on the skill inferences and user role, tenant, and module context,.

### CROSS-REFERENCE TO RELATED APPLICATIONS

This application claims the benefit of, and priority to, the following U.S. provisional patent applications, each of which is incorporated herein by reference in its entirety: i) U.S. Provisional Patent Application No. 63/792,544, filed Apr. 22, 2025; ii) U.S. Provisional Patent Application No. 63/792,764, filed Apr. 22, 2025; iii) U.S. Provisional Patent Application No. 63/794,296, filed Apr. 24, 2025; and iv) U.S. Provisional Patent Application No. 63/795,448, filed Apr. 27, 2025. The contents of the aforementioned applications are incorporated herein by reference in their entireties.

### FIELD OF THE INVENTION

Embodiments of the present invention relate generally to assistance, navigation, and training applications, and more particularly to systems (which may be AI-powered or implemented using rules, logic, decision trees, or other computational methods, with AI as an optional enhancement, or any combination thereof) and methods for delivering a modular, all-in-one platform whose user interface (UI) automatically and dynamically changes based on AI inference, training, user telemetry, role, tenant, and module context and providing an integrated Digital Skills Training and Confidence System (DSTCS) overlay to guide users—especially individuals experiencing memory, cognitive, motor, sensory, or confidence-related challenges (including but not limited to those experiencing dementia, cognitive decline, or other conditions), as well as individuals who may benefit from memory-anchored navigation tied to familiar people and routines, as well as their caregivers, family members, and support persons-through beginner and intermediate digital interactions across any device, platform, or interface modality (including but not limited to smartphones, tablets, ambient computing environments, spatial computing, extended reality (XR) systems including augmented reality (AR), virtual reality (VR), and mixed reality (MR), holographic interfaces, in-the-air interfaces, voice-only systems, and future emerging platforms), including adaptive touch handling, shaky-hand and nail-tap detection, gestural error correction, stepwise prompts for any digital task or interaction, emotional reassurance interface responses as part of accessibility features, and behavioral reward mechanisms that unlock identified and usable modules through a guided modular assembly and graduation experience.

### BACKGROUND OF THE INVENTION

Many individuals, including seniors, veterans, individuals with disabilities, cognitively overloaded adults, caregivers, and teens, struggle with fragmented digital ecosystems. They must juggle multiple single-purpose applications for medication reminders, appointments, finances, transportation, community engagement, worship, mental health, and entertainment. This fragmentation increases cognitive burden, reduces adoption, and creates safety gaps.

Existing applications are typically static and siloed. A senior may use one app for medication reminders, another for video calls, another for Bible study, and another for transportation. Each app has its own interface and navigation model, often with small touch targets, complex menus, and inconsistent gestures. These experiences are not optimized for shaky hands, nail tapping, low digital literacy, or cognitive variability.

While there are accessibility features (e.g., larger fonts, screen readers, basic touch accommodations), they generally do not form an integrated module that infers and reshapes the UI and workflows dynamically based on: i) real-time and historical behavioral telemetry; ii) role-based context (e.g., senior vs. caregiver vs. clinician vs. teen); iii) multi-tenant organizational context (e.g., hospital, church, employer, benefits provider); and iv) the user's current digital skills level and confidence.

Conventional “digital skills training” efforts are often external to the applications being trained, delivered as generic tutorials, web pages, or separate training apps. These approaches are not tightly coupled to the real application states and context. Further, they fail to adapt touch behavior to shaky or uncertain hands in real-time and lack fine-grained telemetry to detect nail taps or micro-errors in tapping, dragging, or pinching. Finally, they do not reward users by unlocking real functionality or modules as confidence in usage grows.

There is thus a need in the art for an integrated platform that unifies multi-domain life assistance, navigation, and communication in a single AI-driven, modular ecosystem and is capable of overlaying a DSTCS control layer that learns from user behavior and actively controls what users can access, unlock, or see, dynamically reshapes UI and workflows, guides users through any digital task or interaction (including but not limited to sending texts, opening links, scanning QR codes, joining video calls, and other tasks), detects how users touch the screen (including finger versus nail contact, shaky or unstable touch patterns) and adapts the interface accordingly, and rewards successful learning paths by unlocking new capabilities inside the same platform, with assistance automatically returning if a user later struggles again.

### SUMMARY OF THE INVENTION

In one aspect, the invention provides a multi-tenant platform (which may be AI-powered or implemented using rules, logic, decision trees, or other computational methods, with AI as an optional enhancement, or any combination thereof) that delivers an all-in-one, white-label-capable ecosystem of modules directed to provide technical functionality in the areas of safety, wellness, faith, social connection, transportation, financial wellbeing, cognitive engagement, animal and human companion care, and other domains, deployable across any device, platform, or interface modality including but not limited to smartphones, tablets, ambient computing environments, spatial computing, extended reality (XR) systems, holographic interfaces, in-the-air interfaces, voice-only systems, and future emerging platforms. The platform exposes modular “Life Navigator” tools and modules that can be identified programmatically and through use of artificial intelligence training and inference means, and mixed and matched per end user or organizational tenant.

According to an embodiment of the present invention, a computer-implemented system for life navigation, digital skills training, and accessibility support comprises: a navigator engine executed by one or more hardware processors and including: (a) a user profile store, comprising a non-transitory computer readable medium, configured to store information for a plurality of users; (b) a tenant configuration store, comprising a non-transitory computer readable medium, configured to store branding information and module configurations for a plurality of organizational tenants; (c) a module registry, comprising a non-transitory computer readable medium, storing definitions of a plurality of life assistance modules; (d) an inference engine (which may utilize artificial intelligence, machine learning, rules-based logic, decision trees, or combinations thereof) configured to receive interaction telemetry from client devices associated with the plurality of users and to generate one or more skill inferences based on the interaction telemetry, wherein the interaction telemetry includes data related to memory-anchored navigation patterns tied to familiar people and routines; (e) a dynamic user interface orchestration engine configured to automatically change a user interface for a given user based at least in part on the one or more skill inferences and on a role, tenant, and module context associated with the given user, wherein the user interface is deployable across any device, platform, or interface modality including but not limited to smartphones, tablets, ambient computing environments, spatial computing, extended reality (XR) systems, holographic interfaces, in-the-air interfaces, voice-only systems, and future emerging platforms; and (f) a digital skills training and confidence system (DSTCS) control layer engine configured to provide task-based training flows within the user interface, provide emotional reassurance interface responses as part of accessibility features, and to control what the given user can access, unlock, or see through a guided modular assembly and graduation experience, wherein the dynamic user interface orchestration engine is further configured to: (i) detect how the given user touches an input surface, including detecting finger versus nail contact and shaky or unstable touch patterns, and adapt at least one layout, control size, or navigation path of the user interface in response to such detected touch characteristics; (ii) cause at least one life assistance module from the module registry to be unlocked for the given user based on completion of one or more DSTCS training flows; and (iii) automatically restore guidance and assistance if the given user later exhibits interaction patterns indicating renewed struggle or difficulty.

According to an embodiment of the present invention, the interaction telemetry comprises: touch coordinates, touch contact area, tap dwell time, gesture trajectories, navigation events, task completion events, and at least one contextual attribute selected from the group consisting of time-of-day, active module set, device form factor, and tenant identity.

According to an embodiment of the present invention, the AI inference engine is configured to classify the given user into at least one digital skill level, and wherein the dynamic user interface orchestration engine is configured to: (a) provide a simplified, stepwise user interface for a first skill level; and (b) provide a more complex, multi-module dashboard user interface for a second, higher skill level.

According to an embodiment of the present invention, the DSTCS control layer engine is configured to implement at least a Level 1 foundational training mode comprising guided exercises for basic interactions (including but not limited to touch, voice, gesture, and other modalities) with emotional reassurance interface responses, and a Level 2 task-oriented training mode comprising guided workflows for any digital task or interaction (including but not limited to sending a text message, opening a link contained in a message, scanning a quick response (QR) code, joining a video meeting, and other tasks), wherein successful completion of training modes through a guided modular assembly and graduation experience controls access to subsequent features and modules.

According to an embodiment of the present invention, a rewards engine configured to: (a) maintain a skills profile for the given user; (b) record completions of the one or more DSTCS training flows; and (c) based on the completions, unlock at least one of: (i) an additional life assistance module; (ii) a user interface theme; and (iii) a badge or achievement indicator.

According to an embodiment of the present invention, the dynamic user interface orchestration engine is further configured to detect how a user touches an input surface (including detecting finger versus nail contact and shaky or unstable touch patterns) and to adjust a size and spacing of interactive targets, to enable snap-to-target behavior, or to alter an interaction modality among touch, voice, gesture, and other modalities based on the detected touch characteristics.

According to an embodiment of the present invention, a computer-implemented method for operating an AI-powered life navigator platform with integrated digital skills training, the method comprising: receiving, from a client device associated with a user, interaction telemetry representing touch inputs, navigation events, and task outcomes; determining, by an AI inference engine, at least one digital skill level and at least one motor stability characteristic for the user based on the interaction telemetry; selecting, by a dynamic user interface orchestration engine, a user interface configuration for the user based on the at least one digital skill level and on a role and tenant context; rendering, at the client device, the selected user interface configuration; providing, by a digital skills training and confidence system control layer, at least one training flow that guides the user through any multi-step digital task or interaction (including but not limited to sending a text message, opening a link, scanning a QR code, joining a video meeting, and other tasks), wherein the control layer determines what the user can access, unlock, or see; monitoring, during the training flow, how the user touches an input surface, including detecting finger versus nail contact and shaky or unstable touch patterns, and providing emotional reassurance interface responses when errors or difficulties are detected; dynamically adjusting at least one element of the user interface in response to the detected touch characteristics; dynamically adjusting at least one element of the user interface in response to the touches indicative of shaky-hand or nail-tap interactions; upon detecting completion of the training flow through a guided modular assembly and graduation experience, updating a skills profile of the user and unlocking at least one life navigator module or feature; and automatically restoring guidance and assistance if the user later exhibits interaction patterns indicating renewed struggle or difficulty.

According to an embodiment of the present invention, the method further comprises: logging a plurality of training completions over time; and transitioning the user from a first interface configuration with stepwise prompts to a second interface configuration with fewer prompts based on the logged training completions.

According to an embodiment of the present invention, the method comprises dynamically adjusting the at least one element of the user interface comprises at least one of: increasing a touch target size, increasing spacing between interactive controls, increasing a dwell time threshold for recognizing a tap, or presenting a confirmation overlay with enlarged controls.

According to an embodiment of the present invention, the method comprises providing the at least one training flow comprises overlaying visual highlights on controls within an existing life assistance module, rather than switching to a separate training application.

According to an embodiment of the present invention, a method for operating a life navigator platform with integrated digital skills training, comprising: executing a navigator engine on one or more hardware processors to maintain a user profile store and a tenant configuration store; storing module definitions in a module registry, comprising a non-transitory computer readable medium; receiving interaction telemetry from client devices associated with users, selected from the group comprising touch coordinates, contact area, tap dwell time, gesture trajectories, navigation events, and contextual attributes such as time-of-day and tenant identity; determining digital skill levels and motor stability characteristics using an AI inference engine based on the interaction telemetry; dynamically selecting a user interface configuration using a dynamic user interface orchestration engine, wherein the adaptation is based on skill inferences, role, and tenant context, and wherein the user interface is deployable across any device, platform, or interface modality including but not limited to smartphones, tablets, ambient computing environments, spatial computing, extended reality (XR) systems, holographic interfaces, in-the-air interfaces, voice-only systems, and future emerging platforms; and implementing a digital skills training and confidence system control layer that includes foundational training for basic interactions across any modality (including but not limited to touch, voice, gesture, and future interaction methods) with emotional reassurance interface responses, and task-oriented training for any digital task or interaction (including but not limited to sending text messages, opening links, joining video meetings, and future tasks not yet conceived) through a guided modular assembly and graduation experience, wherein the control layer determines what users can access, unlock, or see, and wherein memory-anchored navigation tied to familiar people and routines is provided as part of the accessibility features; and maintaining a skills profile for users, recording training completions, and unlocking life navigator modules or interface elements based on training progress, wherein shaky-hand or nail-tap interactions are detected and the interface is adjusted accordingly.

According to an embodiment of the present invention, the method further comprises receiving interaction telemetry that includes touch coordinates, contact area, tap dwell time, gesture trajectories, navigation events, and contextual attributes such as time-of-day and tenant identity.

According to an embodiment of the present invention, the method further comprises the AI inference engine classifying users into digital skill levels, and the UI orchestration engine provides a simplified interface for lower skill levels and a complex dashboard for higher skill levels.

According to an embodiment of the present invention, the method further comprises implementing a digital skills training and confidence system overlay that includes foundational training for basic interactions and task-oriented training for actions such as sending text messages and joining video meetings.

According to an embodiment of the present invention, the method further comprises maintaining a skills profile for users, recording training completions, and unlocking life assistance modules, user interface themes, or badges based on training progress.

According to an embodiment of the present invention, the method further comprises the UI orchestration engine adjusting touch target size, spacing, and interaction modality based on detected shaky-hand or nail-tap patterns.

According to an embodiment of the present invention, the method further comprises receiving interaction telemetry from a client device, determining digital skill levels and motor stability characteristics using an AI inference engine, and selecting a user interface configuration based on skill levels, role, and tenant context.

According to an embodiment of the present invention, the method further comprises rendering the selected user interface on a client device and providing a training flow that guides users through tasks such as sending text messages, opening links, and joining video meetings.

According to an embodiment of the present invention, the method further comprises dynamically adjusting user interface elements in response to shaky-hand or nail-tap interactions and updating user skills profiles upon training completion.

A distinguishing feature is an AI inference engine that continuously processes telemetry signals (touch interactions, tap timing, gesture success/failure, task completion patterns, hesitation, navigation paths, device capabilities, environmental signals) along with user metadata (role, age band, cognitive profile tags, tenant type, enabled modules) to automatically and dynamically change the user interface. Changes can include, but are not limited to, enlarging or collapsing UI regions; reordering or hiding modules, actions, or navigation controls; swapping layouts (e.g., grid vs. list, step wizard vs. dashboard); introducing “training wheels” such as larger buttons, confirm dialogs, slower animations, or single-choice flows; and escalating or de-escalating assistance (e.g., voice-guided steps, overlays, or automatic launching of the DSTCS helper).

In another aspect, embodiments of the present invention introduce an integrated Digital Skills Training and Confidence System (DSTCS) overlay that functions as a cross-cutting layer across the Life Navigator modules and tenant-customized apps. The DSTCS may include, but is not limited to: Level 1 (Foundational) training for basic device and app interactions (e.g., single tap, long press, swipe, entering short text, acknowledging a notification); Level 2 (Task-Oriented) training that walks users through concrete, real-world workflows, including sending and responding to text messages, tapping a link, scanning a QR code, and joining a video meeting (e.g., Zoom or similar); adaptive touch sensing, including detection and modeling of shaky-hand patterns, nail-tap patterns, and improper or ambiguous touches, with dynamic adjustment of hit areas, thresholds, required dwell time, and confirmation behavior; stepwise prompts and overlays that guide users through tasks with clear, minimal instructions, visual highlighting, optional voice narration, and emotional reassurance interface responses that provide encouragement and support during task completion; and a behavioral reward engine that associates successful completion of DSTCS steps through a guided modular assembly and graduation experience with unlocking additional Life Navigator modules, features, themes, or privileges, thereby motivating continued engagement and providing a measurable “skills ladder,” wherein memory-anchored navigation tied to familiar people and routines is integrated throughout the training progression.

In some embodiments, the platform is multi-tenant and white-label capable, enabling organizations (e.g., hospitals, churches, employers, insurers, senior living communities, animal shelters, tourism bureaus) to: deploy branded Life Navigator instances to their populations; select or define module bundles tailored to cohorts; configure DSTCS paths and minimum skill checkpoints required to access sensitive workflows (e.g., medication adjustments, financial transfers, or video visit initiation); and receive aggregated, privacy-respecting analytics on digital skills progression across their user base.

In further aspects, embodiments of the present invention provide methods and computer-readable media for implementing the described AI-driven dynamic UI and DSTCS overlay, including: receiving contextual data and user interaction signals; inference and classification to estimate skill level, motor stability, and confidence; real-time decisioning to adjust UI, prompts, and allowed flows; and logging of progress and rewards to evolve the user's personalized life navigation experience over time.

Additional embodiments include specialized configurations for dual human-animal safety and welfare scenarios, where Life Navigator modules coordinate with wearable devices, drones, cameras, and caregiver dashboards to protect both vulnerable humans and animals, while still employing the DSTCS overlay to ensure that novice caregivers can successfully use the tools.

### BRIEF DESCRIPTION OF THE DRAWINGS

The invention will be more fully understood from the following description of certain embodiments, taken in conjunction with the accompanying drawings. The drawings are schematic and not to scale and are meant for exemplary purposes only and should not be construed as limiting.

FIG. 1 is a schematic diagram of an AI-powered Life Navigator system including a navigator engine, multi-tenant data store, and client devices, in accordance with an embodiment of the present invention.

FIG. 2 is a block diagram of a Life Navigator engine illustrating modules for AI inference, dynamic UI orchestration, module registry, tenant configuration, and DSTCS overlay, in accordance with an embodiment of the present invention.

FIG. 3 is a flowchart illustrating a method for dynamically adapting a user interface based on user role, tenant, module context, and AI inference from telemetry, in accordance with an embodiment of the present invention.

FIG. 4 is a schematic view of the DSTCS overlay interacting with underlying Life Navigator modules and UI components, in accordance with an embodiment of the present invention.

FIG. 5 is a flowchart illustrating a Level 1 DSTCS session for basic touch and gesture training, including shaky-hand and nail-tap detection, in accordance with an embodiment of the present invention.

FIG. 6 is a flowchart illustrating a Level 2 DSTCS workflow for guiding a user through sending a text message and opening a link, in accordance with an embodiment of the present invention.

FIG. 7 is a flowchart illustrating a Level 2 DSTCS workflow for guiding a user through scanning a QR code and joining a video meeting, in accordance with an embodiment of the present invention.

FIG. 8 is a schematic representation of a behavioral rewards engine for unlocking modules, themes, and features based on DSTCS progression, in accordance with an embodiment of the present invention.

### DETAILED DESCRIPTION OF EMBODIMENTS

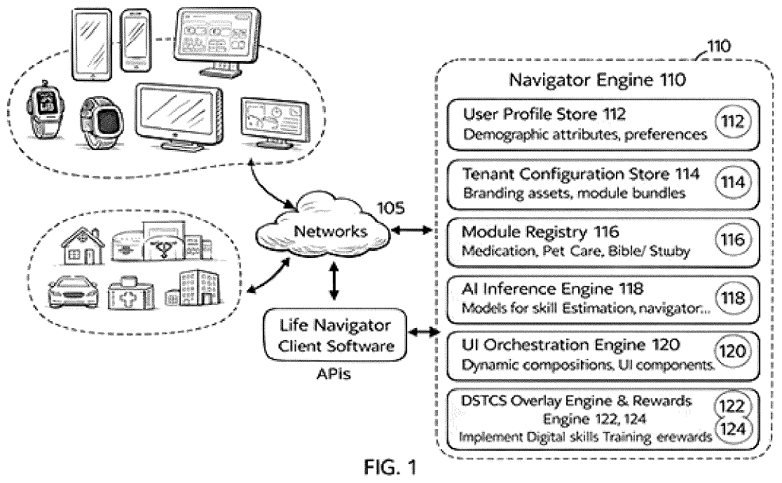

Referring to FIG. 1, a navigator system 100 may include a navigator engine 110 in communication with multiple devices via one or more networks 105. The devices can include smartphones, tablets, smart displays, kiosks, wearable devices, televisions, and other computing endpoints, such as those located in homes, vehicles, clinics, workplaces, churches, and community settings.

The navigator engine 110 may be implemented as one or more backend services, cloud platforms, or on-premises servers, or other computing hardware, whether local or remote. The navigator engine can comprise one or more of: a user profile store 112, which may include, but is not limited to, demographic attributes, declared preferences, module access lists, and tenant memberships; a tenant configuration store 114, comprising one or more of branding assets, module bundles, business rules, content libraries, and DSTCS policy configurations for each tenant (hospital, church, employer, etc.); a module registry 116 listing available Life Navigator technically implemented modules for various practical applications (e.g., Medication, Companion Buddy, Pet Care, Faith & Bible Study, Teen MoodMap, Driver Safety, Financial Snapshot, Animal Safety, Tourism Concierge, etc.); an AI inference engine 118, comprising models for user skill estimation, motor stability (e.g., tremor detection), navigation patterns, sentiment and engagement, and task success prediction; a UI orchestration engine 120, which is configured for dynamically composing, arranging, and rendering UI components and flows based on AI outputs and context; and a DSTCS overlay engine 122 and rewards engine 124, which collectively are configured to implement the digital skills training, stepwise guidance, emotional reassurance interface responses, memory-anchored navigation tied to familiar people and routines, error handling, guided modular assembly and graduation experience, and rewards logic.

Client devices may execute Life Navigator client software 130 that communicates with the navigator engine 110 via APIs or other software, hardware or some combination thereof connector means. The client software can be deployed, for instance, as a native app, a progressive web app, an embedded widget, or a white-labeled application, depending on tenant preferences.

The system may be multi-tenant, meaning that a single underlying platform serves multiple organizations while isolating branding, configuration, and data. A tenant for seniors, a tenant for veterans, and a tenant for youth can all share the same core Life Navigator engine 110, each with its own modules, presentations, and DSTCS flows, in accordance with an embodiment of the present invention.

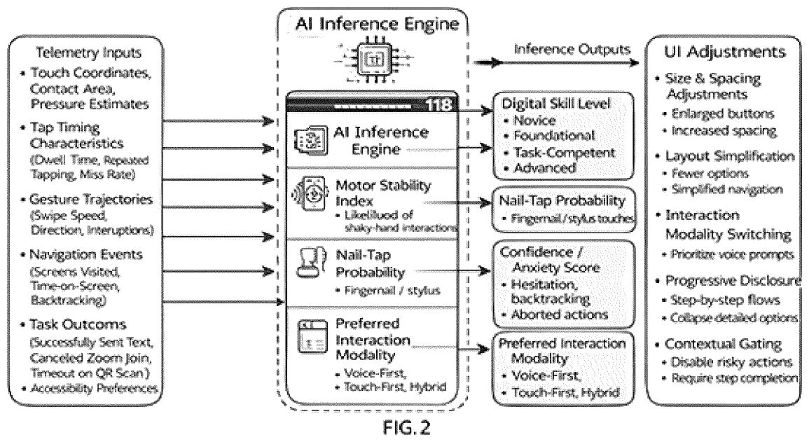

Referring to FIG. 2, an AI inference engine 118 is shown, configured to receive telemetry from the client software 130, which may comprise: touch coordinates, contact area, and pressure estimates; tap timing characteristics (e.g., dwell time, repeated tapping, miss rate); gesture trajectories (e.g., swipe speed, direction, interruptions); navigation events (e.g., screens visited, time-on-screen, backtracking); task outcomes (e.g., successfully sent text, canceled Zoom join, timeout on QR scan); and contextual signals (e.g., time of day, network quality, active modules, screen scale, accessibility preferences).

According to an embodiment of the present invention, the AI inference engine 118 applies one or more machine learning models, rule-based logic, or hybrids, to infer one or more of: digital skill level (e.g., DSTCS Level 0: novice, Level 1: foundational, Level 2: task-competent, Level 3+: advanced); a motor stability index reflecting the likelihood of shaky-hand interactions; a nail-tap probability, indicating that touches are being made with a fingernail, stylus edge, or other suboptimal contact; a confidence or anxiety score derived from hesitation, repeated backtracking, and aborted actions; and a preferred interaction modality (e.g., voice-first, touch-first, hybrid).

In certain preferred embodiments, the UI orchestration engine 120 uses these inferences to automatically and dynamically change the user interface without requiring the user to explicitly select a “mode.” Non-limiting examples of dynamic UI changes may include, but are not limited to: size and spacing adjustments: Enlarging buttons, expanding hit targets, adding spacing between controls when shakiness or nail-taps are detected; layout simplification: reducing the number of simultaneous choices, converting multi-column layouts to single-column flows, or collapsing advanced options behind a “More” drawer for novice users; progressive disclosure (e.g., showing only the next best step for Level 1 users, while revealing full dashboards and analytics for caregivers or advanced users); interaction modality switching, such as enabling or prioritizing voice prompts, voice confirmation, and emotional reassurance responses when the system detects repeated touch errors or high anxiety; contextual gating, such as temporarily disabling certain high-risk actions (e.g., canceling medication reminders, altering safety contacts) until a user has successfully completed relevant DSTCS steps. One of ordinary skill in the art would appreciate that there are numerous types of dynamic UI changes that could be configured and executed by embodiments of the present invention, and embodiments are contemplated for use with any such changes, including combinations thereof.

In a preferred embodiment, these changes may be continuous and adaptive over time. A user who initially sees very large, step-by-step buttons may gradually transition to richer dashboards as the DSTCS overlay records consistent success and improved motor stability. In still further embodiments, per-tenant overrides allow an organization to constrain, prefer, or customize certain dynamic behaviors. For example, a hospital may require that certain consent screens always appear, regardless of inferred skill level, while a church tenant might prioritize faith-related content modules on the main screen for its community.

According to an embodiment of the present invention, the module registry 116 supports a wide variety of modules, including but not limited to: core life assistance, such as generation and implementation of task lists with memory-anchored navigation tied to familiar people and routines, calendar, appointment scheduling, medication reminders, hydration prompts, mobility reminders, or any combination thereof; social and communication interaction connectivity, such as video calling, messaging, group chat for caregivers, mood check-ins, journaling, announcements and events; wellness and mental health interaction and connectivity, such as grounding exercises and breathing tools; goal setting and planning connectivity, such as automatic generation of goal walls, school planners, safe social connections; tourism and local living connectivity, such as connectivity or generation of neighborhood discovery means (e.g., local reviews, local reservations, local buzz/hotspot information), local volunteer opportunities, tourism itineraries; financial and legal connectivity, such as budget snapshots, bill reminders, basic legal document organizers, benefits access, including automatic input/receipt/processing of financial data and generation of such reminders and documents via an AI based system trained on data, with models generated and configured to optimize results from such training data.

According to a preferred embodiment of the present invention, each module comprises computer-executable instructions for generating and providing UI components, data schemas, permission rules, and DSTCS dependencies (e.g., “user must complete Level 2: open a text and respond” before enabling two-way messaging in a high-risk scenario). For end users, the overall experience may resemble a guided modular assembly application, in which users, families, or organizations progressively assemble a personal Life Navigator by choosing modules that best fit their circumstances, with the system providing graduated access to modules based on demonstrated competency through the DSTCS progression system. The dynamic UI engine and DSTCS overlay ensure that this assembly remains usable even for novice or physically-limited users. In certain preferred embodiments, the AI systems integrated into or working with the system are configured to identify and/or select appropriate modules and generate optimized UIs based on its trained models and inference capabilities.

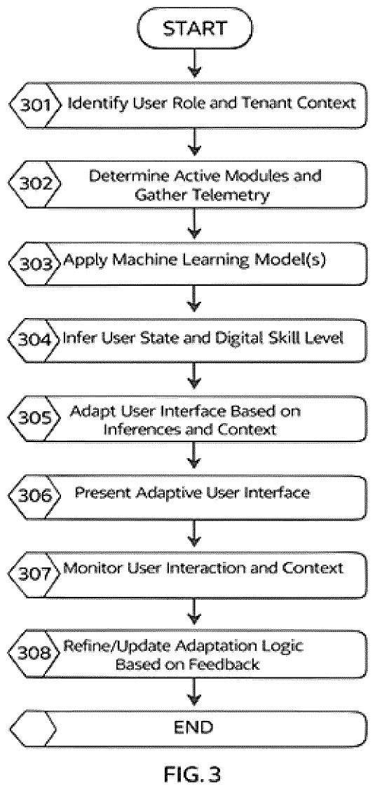

Turning now to FIG. 3, a flowchart illustrating a method for dynamically adapting a user interface based on user role, tenant, module context, and AI inference from telemetry, in accordance with an embodiment of the present invention. FIG. 3 illustrates an example method for dynamically generating and updating an adaptive user interface for a modular, multi-tenant platform, where the user interface is adapted based on (i) a user's role, (ii) a tenant context, (iii) active modules, and (iv) AI/ML inference from telemetry and observed interaction data. In some embodiments, the method is performed by one or more computing systems including a user device (e.g., smartphone, tablet, smart display), a platform server (or cloud service), and/or an on-device or server-side inference engine. One or more steps may be performed in a different order, repeated, omitted, or combined, depending on implementation. While described with respect to seniors and accessibility-focused embodiments, the method is applicable to any user population, including caregivers, administrators, vendors, family members, and other roles.

At step 301, the system identifies a user role and a tenant context associated with the current session or interaction. The user role may include, by way of example, a senior/end-user, caregiver, family member, clinician/provider, organizational administrator, module publisher, vendor, or support staff role. The tenant context may include an organization, community, facility, sponsor, white-labeled instance, managed group, household, or other logical tenant boundary. In various implementations, identifying the user role and tenant context includes one or more of: retrieving a role designation from an identity provider or access-control service; mapping a user identifier to a tenant identifier in a tenant registry; applying policy rules specifying which modules, features, layouts, and visual themes are permitted or preferred for the identified role/tenant; establishing one or more default accessibility constraints (e.g., font size minimums, contrast settings, simplified navigation, reduced UI density) for the identified role/tenant; and/or retrieving memory-anchored navigation preferences associated with familiar people, routines, or locations that provide contextual orientation cues for the user.

At step 302, the system is configured to determine active modules and gather telemetry data. The system determines one or more active modules for the identified user/tenant and gathers telemetry associated with the user, device, and interaction context. The active modules may correspond to enabled or subscribed modules (e.g., reminders, medication, messaging, transportation, community activities, video calling, safety, faith content, and any other digital task or interaction pattern, including those not yet conceived), including modules that are temporarily active based on schedule or context. Telemetry may include, without limitation: interaction telemetry (tap locations, tap timing, dwell time, scrolling behavior, backtracks, repeated attempts, cancellations, error events); device telemetry (screen size, orientation, touch sampling rate, accessibility settings, input modality such as touch vs. voice); contextual telemetry (time of day, location context if permitted, network conditions, device movement indicating tremor or instability); performance telemetry (latency, rendering delays, resource usage); historical usage telemetry (module usage frequency, abandonment patterns, completion rates); and/or safety/accessibility telemetry (mis-taps, “fat-finger” indicators, tremor indicators, nail-tap indicators, finger-pad versus nail-edge touch patterns, touch stability metrics, timeouts, confusion signals such as repeated opening/closing of the same screen).

In some embodiments, telemetry is collected in a privacy-preserving manner (e.g., minimization, on-device processing, aggregation, or anonymization), and may be gated by user consent and applicable policy.

At step 303, the system applies one or more adaptive logic components to the gathered telemetry and context signals. The adaptive logic may be implemented using machine learning (ML) models, rule-based systems, decision trees, logic-based inference engines, or any combination thereof. The model(s) may execute on-device, in a server environment, or in a hybrid configuration. In various embodiments, applying the adaptive logic may include, but is not limited to: selecting an appropriate logic implementation or version based on role/tenant and device capabilities (e.g., lightweight on-device rule engine vs. richer cloud-based ML model); evaluating telemetry features (including short-term session features and long-term historical features); producing intermediate assessments (e.g., confidence measures, skill estimates, friction scores, accessibility risk scores) using ML inference, rule evaluation, decision tree traversal, or hybrid approaches; and/or applying rules, policies, or constraints that bound or shape outputs (e.g., “always provide an SOS affordance,” “do not surface commerce modules for a restricted tenant,” “enforce minimum font size,” etc.).

At step 304, based on the adaptive logic output(s), the system infers a user state and/or a digital skill level. The inferred user state may include, for example, a comfort/confidence state, a confusion/frustration state, a cognitive-load estimate, a tremor or shaky-hand likelihood, a visual acuity constraint, or a task-intent estimate (e.g., “trying to message family,” “trying to join a meeting,” “trying to request a ride”). Digital skill level can be represented as a categorical level (e.g., novice/intermediate/advanced), a continuous score, a set of competency tags (e.g., “can open links,” “can scan QR,” “needs guided prompts for text messaging”), or a dynamic profile that varies per module or task category. In some embodiments, the system infers skill level per module (e.g., user is proficient in reminders but novice in video calling), and may infer which UI patterns are most effective for the user (e.g., large “one-tap” buttons, guided wizards, reduced branching, voice-first prompts, confirmation steps).

At step 305, the Digital Skills Training and Confidence System (DSTCS) actively controls and adapts the user interface based on the inferred user state/skill level and the identified role/tenant/module context. The DSTCS functions as a control layer that determines what users can access, unlock, or see, and how the interface behaves, rather than merely providing tutorials or help screens. Adaptation may include generating a new UI, selecting among UI variants, modifying parameters of a UI template, or applying accessibility transformations. Non-limiting examples of adaptations include: layout adaptation: reducing the number of visible choices, converting lists to large tiles, prioritizing “next best action,” rearranging navigation, or collapsing advanced options; interaction adaptation: increasing target sizes, adding confirmation prompts, adding “undo,” enabling tremor filtering, detecting and adapting to nail-tap versus finger-pad touch patterns, changing gesture requirements, enabling “press-and-hold” alternatives, or adding voice-guided controls; content and module adaptation: surfacing the most relevant module(s), suppressing rarely used modules, suggesting an onboarding/tutorial flow, or presenting role-specific dashboards (e.g., caregiver dashboard vs. senior dashboard); visual adaptation: increasing font size, contrast, spacing, and readability; simplifying iconography; adding photo-based shortcuts; and/or guidance adaptation: enabling step-by-step wizards, contextual micro-instructions, progress indicators, “coach marks,” or emotionally reassuring interface responses that acknowledge user effort and provide encouragement (e.g., “You're doing great,” “Take your time,” “We're here to help”). In some embodiments, the adaptation decision is constrained by tenant policy, compliance requirements, or safety constraints, such that the system never removes mandatory safety affordances and never presents restricted features to roles without permission.

At step 306, the system presents (renders) the adapted user interface on the user device. Presenting may include pushing a server-generated UI definition to the client, rendering a locally generated view, or rendering a hybrid UI with server-provided configuration. In some embodiments, presenting includes: caching the adapted configuration for performance; displaying a minimal “home” screen optimized for the inferred skill level and incorporating memory-anchored navigation elements referencing familiar people or routines; presenting a guided task interface (e.g., a “single pathway” wizard) when the inferred state indicates confusion or low skill, with emotionally reassuring prompts; and/or presenting an “assist” overlay or help affordance (e.g., immediate caregiver call, SOS, or contextual help) with calming, supportive messaging.

At step 307, the system monitors ongoing user interaction and context after presenting the adaptive user interface. Monitoring may collect additional telemetry as the user proceeds, including whether the adaptation improved outcomes (e.g., reduced errors, faster completion, fewer backtracks, higher task success). In some embodiments, monitoring includes detecting triggers such as: repeated mis-taps; repeated navigation loops; abandonment or timeouts; repeated activation of help; a shift in device context (e.g., user walking, increased tremor, poor network); completion of a task or milestone within a module; and/or changes to the active module set due to tenant policy updates or subscriptions.

At step 308, the system refines or updates the adaptation logic based on feedback obtained from monitored interactions and context changes. Feedback may include explicit feedback (e.g., “this is too hard,” “make text bigger”) and/or implicit feedback (e.g., error rates, success rates, completion time, help usage). Refining/updating can include one or more of: updating a user profile or skill estimate (global or per module); selecting a different UI variant or increasing the level of guidance; tuning thresholds for “novice mode” vs. “standard mode;” adjusting the prioritization of modules and actions; updating a policy or ruleset used to constrain model outputs; and/or generating training data signals to improve future inference (subject to privacy/consent constraints). The method may then return to step 302, step 303, or step 305 to continue iteratively adapting the user interface over time as the user's needs, context, or skill changes. If the system detects that a user who previously demonstrated proficiency begins to struggle again (e.g., increased error rates, repeated mis-taps, task abandonment), guidance and assistance automatically return to support the user, creating a continuous adaptive loop.

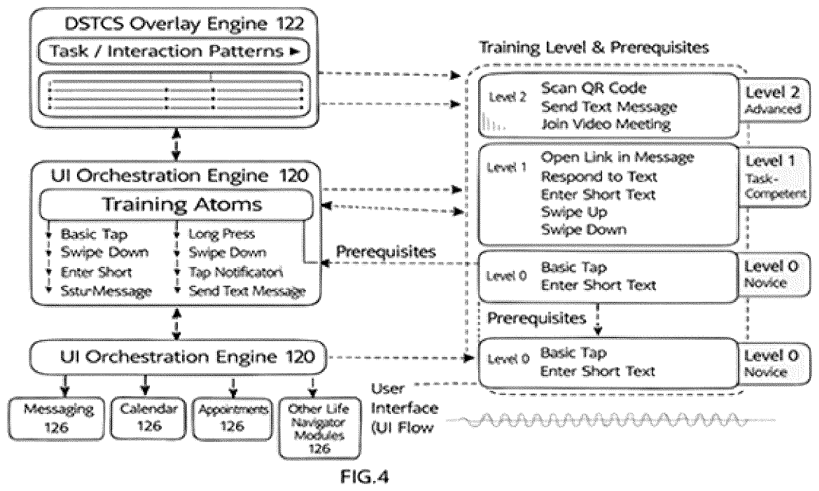

Referring to FIG. 4, in a preferred embodiment of the present invention, the DSTCS overlay engine 122 sits logically above the Life Navigator modules and the UI orchestration engine. Rather than being a separate application, DSTCS may be configured to inject guidance and adaptation into real technical workflows within the Life Navigator environment. The DSTCS engine is configured to associate each task or interaction pattern with one or more training atoms. Training atoms may include any digital interaction or task, such as basic tap, long press, swipe down, swipe up, enter short text, tap notification, send text message, respond to text, open link in message, scan qr code, accept video invitation, join video meeting, acknowledge safety alert, confirm medication taken, voice commands, gesture-based inputs, spatial interactions, or any other interaction modality or task type, including those performed on future platforms and devices, or any combination thereof. Each training atom can be linked to a DSTCS Level and prerequisites. For instance, a “send_text_message” interaction may require successful completion of Level 1 atoms “basic_tap” interaction and “enter_short_text” interaction.

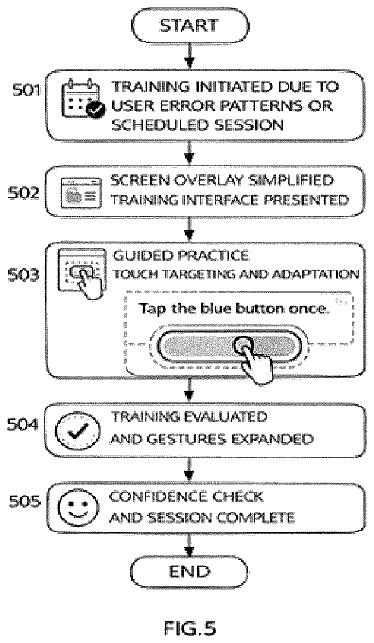

According to an embodiment of the present invention, a Level 1 DSTCS may be configured to focus on foundational device and/or interface interactions and basic confidence-building. Referring to FIG. 5, a Level 1 session may proceed as follows. At step 501, The user initiates training voluntarily, or the system schedules training when repeated interaction errors are detected. At this point, in step 502, the overlay temporarily replaces or augments the current Life Navigator screen with a simplified training surface.

At step 503, The DSTCS presents a single highlighted target (e.g., a large button) and instructs the user, via text and optionally voice, to “Tap the blue button once.” The system records the user's touch input, including position, shape, and duration. If taps are consistently off-target, the engine 118 updates a personalized offset and enlargement model, enlarging the tap zones and adjusting target locations for the user. The system specifically detects touch-type patterns to distinguish between finger-pad touches and nail-edge touches. Nail taps are characterized by small contact area, repeated low-contact signals near the edge of capacitive sensitivity, high positional variance, and reduced contact duration compared to finger-pad touches. Upon detecting nail-tap patterns or shaky-hand behavior, the system adapts by increasing dwell-time thresholds, adding “sticky” touch regions, enlarging target zones, and providing emotionally reassuring feedback (e.g., “We detected a nail tap; please try using the pad of your finger—or we can increase button size for you. You're doing fine, and we're here to help you succeed.”). This touch-type detection and adaptive response is a core differentiating feature that improves accessibility and usability.

At step 504, as the user demonstrates repeatable success (e.g., N consecutive correct taps under time T), the DSTCS marks the basic_tap atom as mastered and begins introducing other gestures (e.g., swiping, long press). Level 1 may also include confidence checks, such as asking the user if they feel comfortable performing the gesture in everyday use or if they prefer to keep larger buttons and step prompts available.

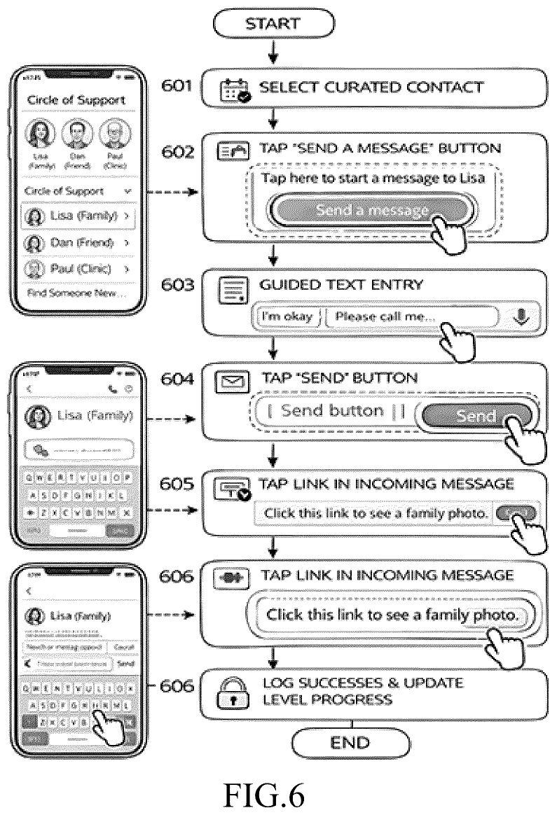

According to an embodiment of the present invention, Level 2 DSTCS builds on foundational skills to help users complete real tasks. Referring to FIG. 6, a Level 2 workflow for sending a text and opening a link is shown. At step 601, the system allows for the selection of a simple, curated contact (e.g., “Lisa (Family)”) from a user's “Circle of Support,” where contacts are presented using memory-anchored navigation cues such as photos, relationship labels, and recent interaction context to aid recognition and selection. At step 602, the system highlights the “Send a message” button and presents an instruction, such as, “Tap here to start a message to Lisa.”

At step 603, the system activates a simplified text-entry field with optional voice dictation and templated starter texts (e.g., “I'm okay,” “Please call me,” “I took my medication.”). At step 604, the system highlights the “Send” button on the UI after the message is composed, optionally with audio feedback and an emotionally reassuring confirmation upon success (e.g., “Great job! Your message to Lisa has been sent.”).

At step 605, the system immediately delivers a simulated or real response from the curated contact containing a link (e.g., “Click this link to see a family photo.”). At step 606, the system then guides (audibly, visually, tactically) the user to tap the link in the UI, optionally magnifying it or presenting it as a large button if nail-taps or misses are detected.

At step 607, the system logs the successful completion of the sequence as mastery of the send_text_message and open_link_in_message atoms and updates its information related to the user, such that recorded successes may unlock or allow for implementation of higher Level workflows.

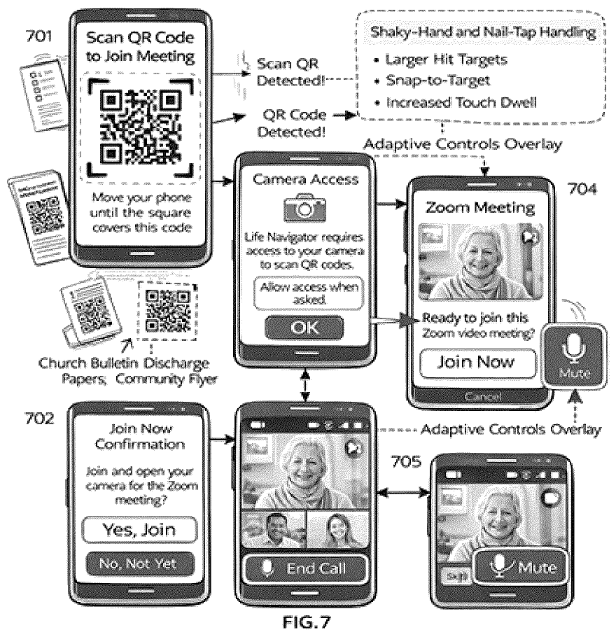

Referring to FIG. 7, a Level 2 flow for QR and video meeting joining may involve: scanning a QR code or other unique identifier (such as on a printed church bulletin, hospital discharge sheet, or community flyer); explaining and highlighting camera permission prompts; showing a simple on-screen frame and asking the user to “Move your phone until the square covers this code”; automatically recognizing the code and pre-filling details for a Zoom or similar video meeting; and confirming with the user before joining, and optionally rehearsing how to mute/unmute and end the call. Throughout Level 2, adaptive touch handling remains active, including detection and adaptation for nail-tap versus finger-pad touch patterns and shaky-hand behavior. If the user struggles with small controls (e.g., Zoom's mute button), the system may overlay larger, DSTCS-specific controls that map to underlying app functions via accessibility APIs, operating system hooks, or direct integration interfaces.

To follow through the process in FIG. 7, at step 701, the system receives data related to a unique identifier, such as processed data from an optical scan of a QR Code containing data to join a meeting. The system could be configured to process the data with knowledge of the user (e.g., with shaky-hand stabilization, and/or nail-tap handling). At this point, the DSTCS initiates a guided task configured for joining a meeting. The user may be prompted to provide a unique identifier (e.g., scan a QR code). The DSTCS may display a simplified “Scan QR” screen and concurrently enable adaptive touch handling, including one or more of a larger hit targets, a snap-to-target behavior, and an increased touch-dwell thresholds to reduce input errors.

During step 701, the DSTCS may also display on a UI an explanation (e.g., in plain language) what a unique identifier (e.g., QR code) is and what will happen after scanning, with emotionally reassuring language (e.g., “This code will open a meeting link. Don't worry-we will ask you before joining, and you can take your time.”), thereby reducing user anxiety and preventing unintended meeting joins.
at step 702, the system activates unique identifier acquisition (e.g., QR scanning and acquire camera access (coached permissions)). The system activates a QR scanning interface and, when required by the operating system, presents or anticipates a camera permission prompt. The DSTCS may coach the user through permission text using simplified instructions consistent with the figure, for example: “Life Navigator requires access to your camera to scan QR codes. Allow access when asked.” In some embodiments, the DSTCS may perform additional supportive actions, such as highlighting relevant permission UI element (e.g., “Allow,” “OK,” or “While Using the App”); providing a short safety explanation (e.g., “Camera access is used only to scan the QR code for this task”); and/or guiding the user through a recovery path (e.g., re-try prompt, or instructions to enable camera access in device settings).

At step 703, the DSTCS presents a visual frame (e.g., a square) and instructs the user to align the unique identifier (e.g., QR code) with the frame, consistent with the figure's guidance such as: “Move your phone until the square covers this code.” In some embodiments, the DSTCS monitors for conditions that commonly cause scanning failure (e.g., excessive motion blur, poor lighting, glare, or camera focus issues) and provides corrective coaching with emotionally supportive language (e.g., “Hold still-you're almost there,” “Move a bit closer,” “Try brighter light-you're doing fine,” “Tilt the paper to reduce glare-no rush, take your time.”). When the unique identifier is successfully recognized, the DSTCS may provide a clear positive confirmation (e.g., “QR Code Detected!”) and transition to a pre-join confirmation interface without immediately joining the meeting.

At step 704, the system uses the recognized unique identifier (e.g., QR code) content to identify a meeting destination (e.g., a URL, meeting identifier, and/or passcode) and pre-fills meeting details for a video or similar electronically or telephonically provided for meeting. The DSTCS then prompts the user with an explicit confirmation step (as depicted) such as “Ready to join this video meeting?” with clear options such as “Join Now” and “Cancel. In some embodiments, the confirmation step includes additional safety and clarity features, such as: displaying or presenting the meeting source context using memory-anchored cues (e.g., “From: Church Bulletin” or “From: Discharge Papers” when available, with familiar visual branding or icons), such as via a UI or another source (e.g., audio source); announcing the meeting name/host if resolved from the link; indicating whether audio/video will start muted; offering emotionally reassuring language (e.g., “Take your time-we'll help you through this”); and/or offering a “practice first” mode that rehearses one or two core actions (e.g., “mute/unmute”) before entering the meeting.

At step 705, upon receiving user confirmation, the system launches or joins the meeting using the meeting link or deep link. During and/or immediately after joining, the DSTCS may present an Adaptive Controls Overlay with large, simplified, high-contrast controls that map to underlying meeting functions, such as Mute and End Call, as shown in FIG. 7. The overlay may be invoked at all times during the meeting for Level 2 users, or selectively invoked based on detected interaction difficulty (e.g., missed taps on the native mute button). In some embodiments, the overlay functions by issuing commands through one or more of: operating system accessibility APIs, UI automation hooks, permitted integrations, or coordinated in-app controls where the meeting function is hosted within the Life Navigator environment.

Throughout the FIG. 7 Level 2 flow, adaptive touch handling remains active. The DSTCS overlay and adaptive logic engine (e.g., AI engine 118, which may implement machine learning, rule-based logic, decision trees, or hybrid approaches) infer shaky-hand behavior and/or nail-tap behavior using telemetry from touch interactions during scanning, confirmation, and in-meeting control operations. Non-limiting inference signals include: (i) dispersion and jitter of touch coordinates during a tap/press; (ii) sequences of missed taps followed by successful taps at nearby coordinates; (iii) contact-area or shape attributes where supported by hardware (e.g., unusually small/irregular contact indicating nail use); and/or (iv) ratios of quick repeated taps to successful stable taps. Upon detecting these patterns, a UI orchestration engine (e.g., UI orchestration engine 120) can apply one or more adaptive mitigations, including: increasing hit target size and spacing; enabling snap-to-target selection; extending allowable dwell duration; confirming critical actions using large confirmation prompts; and/or suggesting voice interaction (e.g., “Say ‘Mute me’”) as a complementary modality. In some embodiments, these mitigations are applied in a tiered manner to preserve user autonomy while improving reliability, for example: (a) enlarge targets; then (b) enable snap-to-target; then (c) introduce confirmation for critical actions; then (d) offer voice-first controls.

The DSTCS overlay and adaptive logic engine 118 (which may implement machine learning, rule-based logic, decision trees, or hybrid approaches) use patterns of touch input to infer shaky-hand or nail-tap behavior. Non-limiting detection methods include: i) analyzing the dispersion and jitter of touch coordinates during a single tap or press; ii) tracking sequences of missed taps followed by successful taps at nearby coordinates; iii) inspecting the area and shape of touch contact where supported by the hardware (e.g., extremely small or irregular contact area may indicate nail usage); and iv) measuring the ratio of quick, repeated taps to successful stable taps. measuring the ratio of quick, repeated taps to successful stable taps.

Upon detecting these patterns, the UI orchestration engine 120 can: increase hit target size and spacing; enable “snap-to-target” behavior where approximate touches snap to the closest intended control; extend allowable touch-dwell duration; confirm critical actions with clear, large confirmation prompts; and/or suggest voice interaction as a complementary modality.

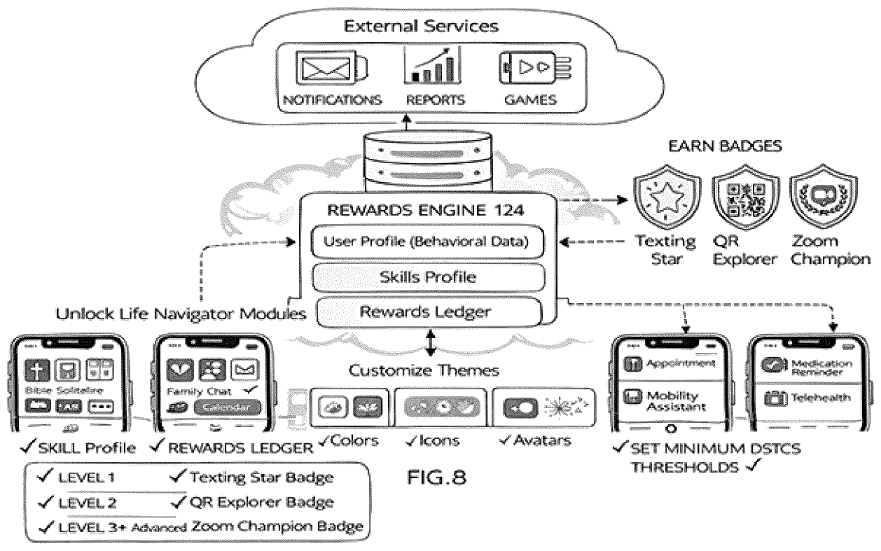

Referring to FIG. 8, according to an embodiment of the present invention, the system includes a rewards engine 124 that maintains (i) a skills profile and (ii) a rewards ledger for each user participating in the DSTCS. The rewards engine 124 supports multiple training modalities (including touch-based, voice-based, gesture-based, and other interaction types), multiple reward types (including badges, unlocks, points, streaks, themes, and other progression indicators), and multiple progression systems that can be customized per tenant, user role, or user preference. The rewards engine 124 cooperates with the DSTCS training layer, the UI orchestration engine (e.g., UI orchestration engine 120), and tenant policy controls to provide a structured progression in which completion of DSTCS “atoms” (micro-skills) and higher-level training sequences (e.g., Level 1 and Level 2) results in controlled unlocks and user-positive reinforcement, while preserving safety and compliance constraints.

In some embodiments, the skills profile includes one or more of: a level designation (e.g., Level 1, Level 2, etc.); one or more per-skill competency markers (e.g., “open a text thread,” “reply,” “send,” “open a link,” “scan a QR,” “join a meeting,” “mute/unmute,” “end call”); one or more per-module competency markers (e.g., user is Level 2 for telehealth/meetings but Level 1 for messaging); one or more confidence scores and/or recency scores; accommodation needs inferred from telemetry (e.g., shaky-hand sensitivity enabled, nail-tap mitigation enabled, enlarged targets preferred, emotional reassurance prompts enabled); memory-anchored navigation preferences (e.g., preferred familiar contacts, routine-based shortcuts, location-based context cues); and/or role/tenant flags that specify permitted unlocks and restricted actions.

In some embodiments, the rewards ledger records awarded items and events, such as: badge identifiers, milestones, and timestamps; unlock events (e.g., module enabled, theme enabled, advanced control enabled); “reward currency” balances (points, stars, streaks); redemption and reversal events; and/or audit metadata for tenant-controlled unlocks (e.g., hospital approval requirements).

According to an embodiment of the present invention, the rewards engine 124 may receive completion signals from the DSTCS layer when the user completes: an individual atom (e.g., successful completion of “tap a button,” “confirm a permission prompt,” “send a message”); a guided flow (e.g., QR scanning and joining a video meeting); a proficiency check (e.g., repeated successful completions over multiple days, or a timed completion threshold); and/or a tenant-required competency threshold (e.g., “telehealth visit training completed”). Completion can be determined using explicit end-of-flow criteria and/or inferred performance telemetry (e.g., low error rate, reduced mis-taps, reduced backtracking, fewer help prompts).

Upon receiving a completion signal, the rewards engine 124 may be configured to evaluate: the user's current skills profile (what is already mastered); the tenant context (e.g., Cardinal Care tenant, hospital tenant, church/community tenant); user role (senior, teen, caregiver, administrator); configured reward rules and constraints (e.g., tenant-defined safety policies, minimum thresholds, restricted flows); personalization signals (user preferences for themes/motifs); and/or pacing controls (to prevent overwhelming unlocks).

Based on this evaluation, the rewards engine 124 selects one or more rewards and/or progression actions. As DSTCS atoms and levels are mastered, the rewards engine 124 may issue one or more outputs selected from the group comprising: module unlocks, theme and personalization unlocks, badges and milestones, and progressive relaxation of training prompts.

Module unlocks within the Life Navigator ecosystem, wherein the rewards engine may unlock additional Life Navigator modules (or enable access to previously hidden modules), such as games, photo albums, messaging/community groups, reminders, concierge tools, or other tenant-approved modules. In some embodiments, unlocks are staged so that a user first receives guided access (with overlays and coaching) before receiving fully unguided access.

Theme and personalization unlocks are comprised of visual themes (colors, icons, avatars, layouts) aligned with user preferences, including theme packs tailored to seniors (e.g., nature, faith), teens (e.g., “Teen GlowUp”), veterans, caregivers, etc. In some embodiments, personalization unlocks are used as low-risk rewards that increase engagement without increasing safety risk.

Badges and milestones unlocks grant badges or other signifiers, such as “Texting Star,” “QR Explorer,” “Zoom Champion,” as well as streak milestones or tiered achievements (bronze/silver/gold). Badges may be displayed in a profile area and/or used to gate optional advanced training.

Progressive relaxation of training prompts while preserving safety constraints rewards competency by allowing the rewards engine 124 to signal the UI orchestration engine to reduce or hide overly basic prompts (e.g., fewer confirmations for non-critical actions), while maintaining safety constraints (e.g., confirmations for emergency actions, financial actions, or tenant-restricted actions). In some embodiments, “relaxation” is not global; it is applied per skill category and can be reinstated if telemetry later indicates difficulty or regression.

In preferred embodiments, organizations can configure minimum DSTCS thresholds that must be met before users can access sensitive flows. For example: a hospital tenant may require completion of a Level 2 “telehealth visit” training before allowing a patient to modify a scheduled visit time, join a telehealth room, or access post-discharge instructions requiring remote clinician interaction; a caregiver organization tenant may require completion of training related to privacy and consent before enabling caregiver reporting or record-sharing features; and/or a teen context may require completion of communication safety training before enabling certain sharing or community features. In some embodiments, the rewards engine 124 enforces these thresholds by issuing allow/deny decisions, gating UI elements, or enabling “guided-only mode” until completion criteria are met.

In some embodiments, after issuing a reward or unlock decision, the rewards engine 124 updates the skills profile and rewards ledger, and notifies the UI orchestration engine to: present an emotionally positive reward notification (e.g., “Congratulations! You unlocked Photo Albums! You're making great progress.”); adjust navigation surfaces to include the newly unlocked module/theme with memory-anchored presentation (e.g., showing the module alongside familiar contacts or routines that might use it); and/or schedule a recommended next training flow that prepares the user for the unlocked capability with supportive, encouraging language. If the system detects subsequent struggle (e.g., increased mis-taps, abandoned tasks), the rewards engine and UI orchestration engine may cooperatively re-enable guidance overlays or recommend refresher atoms, thereby maintaining a safe progression.

### Example Use Cases

Senior: “Grandma Rose”—Rose receives a personalized Cardinal Care Life Navigator built by her granddaughter, Sarah. The interface prominently displays photos of Sarah and other family members alongside daily routine anchors (morning coffee time, afternoon walk schedule) to provide familiar, memory-anchored navigation cues. Initially, she has shaky hands and low confidence. The system detects high miss rates on taps and automatically increases button sizes and spacing, while providing gentle, reassuring voice feedback such as “That's okay, Rose, let's try again together” to maintain confidence and reduce anxiety during the learning process. The DSTCS Level 1 guides her through tapping, scrolling, and acknowledging reminders. Once she masters Level 2 texting, she unlocks a family photo carousel and a Bible devotional module. Over time, her interface adapts to resemble a curated dashboard with fewer training overlays.

Veteran: “Mike”—Mike uses a Vet Navigator configuration, including PTSD calming tools and VA appointment tracking. The DSTCS ensures he can reliably open links from his VA care team and join video support groups via QR codes on printed flyers, with calming interface responses that acknowledge stress triggers and provide supportive messages like “You're doing great, Mike” during challenging interactions. The system rewards his progress by unlocking peer-support chat and job-transition resources.

Teen: “Emma”—Emma, with mild cognitive challenges, uses a Teen Life Navigator with journaling, school planning, and mental health tools. The DSTCS Level 2 walkthrough ensures she can join remote tutoring sessions and respond to teacher messages safely, with encouraging feedback messages like “Nice work, Emma!” and “You're getting better at this!” to build confidence and maintain engagement. Rewards include custom themes and achievement badges.

Caregiver+Animal Companion Scenario—A caregiver managing a senior and an emotional support animal uses a combined Life Navigator and animal companion configuration. The DSTCS overlay helps the caregiver learn to navigate dashboards showing the senior's medication schedule and the pet's feeding schedule, alerts from wearables, and emergency protocols. As the caregiver masters tasks such as responding to alerts and starting video check-ins, the system provides reassuring feedback acknowledging the complexity of their caregiving role, and new analytics and customization modules unlock.

### Additional Definitions

In certain embodiments, this disclosure provides a computer-implemented method for performing the operations of the systems described herein. The computer-implemented method may be executed by one or more processors configured to carry out the functional steps of the various modules and computational structures herein. Each step of the computer-implemented method corresponds to a respective operation performed by one or more elements of the system architecture. The computer-implemented method may include, without limitation, receiving and processing multimodal data, generating predictive and temporal models, constructing and simulating candidate intervention sets, and producing an optimized action plan. The method steps may be implemented in software, hardware, firmware, or any combination thereof.

In another aspect, this disclosure provides non-transitory computer readable medium having computer executable instructions stored thereon. When executed by one or more processors, the computer executable instructions cause the processors to perform the steps of the computer-implemented method described herein. The program code implementing the disclosed functionality may be organized as one or more modules or sub-routines that can be executed independently or in combination to perform the operations of system. Such program code may be written in any suitable programming language and may include compiled, interpreted, or intermediate code. The instructions may be stored together in a single executable file or distributed across multiple linked libraries.

The non-transitory computer-readable medium may comprise any tangible or non-transitory data storage device capable of retaining the program instructions, including magnetic disks, optical disks, semiconductor memory devices, solid-state drives, or other electronic storage media. In some embodiments, the computer-readable medium may be a hardware-embedded component such as an integrated circuit field-programmable gate array, or system-on-chip configured to execute at least part of the disclosed method.

It will be appreciated that the system, method, and non-transitory computer-readable medium described herein may be implemented individually or in combination. The method operations may be executed by the system or by any computing architecture configured to perform equivalent functionality. Similarly, the non-transitory computer-readable medium provides executable instructions that, when executed by one or more processors, implement the method steps using the system architecture described herein. Thus, the system, method, and non-transitory computer-readable medium collectively enable the life navigation platform with digital skills training and confidence system to provide personalized assistance and adaptive user interfaces across multiple devices and interaction modalities.

To aid in understanding the detailed description of the systems and methods according to the disclosure, a few express definitions are provided to facilitate an unambiguous disclosure of the various aspects of the disclosure. Unless otherwise defined, all technical and scientific terms used herein have the same meaning as commonly understood by one of ordinary skill in the art to which this disclosure belongs.

It is noted that, as used in this specification and the appended claims, the singular forms “a,” “an,” and “the” include plural referents unless the context clearly dictates otherwise.

The terms “including,” “comprising,” “containing,” and “having,” and variations thereof, are intended to encompass the listed items and equivalents thereof, as well as additional subject matter, unless otherwise specified.

The phrases “in some embodiments,” “in various embodiments,” and similar expressions may be used repeatedly throughout the disclosure. Such phrases do not necessarily refer to the same embodiment, although they may, unless the context dictates otherwise.

The terms “and/or” or “/” refer to any one of the listed items, any combination of the listed items, or all of the listed items.

As used herein, the terms “approximately” or “about,” when applied to one or more values of interest, refer to values that are similar to a stated reference value. In some embodiments, the term “approximately” or “about” refers to a range of values within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value, unless otherwise indicated or evident from the context (except where such a range would exceed 100% of a possible value). Unless indicated otherwise herein, the term “about” is intended to include values proximate to the recited range that are equivalent in terms of the functionality of the individual ingredient, the composition, or the embodiment.

It is to be understood that wherever numerical values or ranges are provided herein, all values and ranges encompassed thereby are intended to fall within the scope of the invention. Moreover, all values that fall within such ranges, including the endpoints, are contemplated by the present disclosure.

As used herein, the term “each,” when referring to a collection of items, identifies individual items within the collection, but does not necessarily refer to all items in the collection, unless explicitly stated or dictated by context.

The use of examples or exemplary language (e.g., “such as”) is intended solely to illuminate aspects of the invention and should not be construed as limiting the scope of the invention unless explicitly recited in the claims. The term “exemplary” is intended to mean “by way of example” and does not imply preference or requirement.

The term “computing device” refers to a device or system that includes a processor and memory. Each device may have its own processor and/or memory, or the processor and/or memory may be shared with other devices as in a virtual machine or container arrangements. The memory will contain or receive programming instructions that, when executed by the processor, cause the computing device to perform one or more operations according to the programming instructions. Examples of computing devices include personal computers, laptop computers, digital display devices, servers, mainframes, virtual machines, containers, televisions, and mobile electronics (e.g., smart phones), and internet-connected wearables (e.g., smart watches and smart eyewear, personal digital assistants, cameras, tablet computers, laptop computers, media players). In a client-server arrangement, the client device and the server are computing devices, in which the server contains instructions and/or data that the client device accesses via one or more communications links in one or more communications networks. In a virtual machine arrangement, a server may be a computing device, and each virtual machine or container also may be considered a computing device.

The terms “processor” and “processing device” refer to a hardware component of an electronic device that is configured to execute programming instructions. Except where specifically stated otherwise, the singular terms “processor” and “processing device” are intended to include both single-processing device embodiments and embodiments in which multiple processing devices together or collectively perform a process.

The terms “memory,” “memory device,” “computer readable medium,” “data storage facility” and the like each refer to a non-transitory device on which computer-readable data, programming instructions or both are stored. Except where specifically stated otherwise, the terms “memory,” “memory device,” “data storage facility” and the like are intended to include single device embodiments, embodiments in which multiple memory devices together or collectively store a set of data or instructions, as well as individual sectors within such devices.

As used herein, the term “storage device” refers to a single or multiple storage devices and/or media (e.g., a centralized or distributed database, and/or associated caches and servers) that store executable instructions and/or data. The term includes, without limitation, solid-state memories, and optical and magnetic media, including memory internal or external to processors. Exemplary storage devices include semiconductor memory devices, (e.g., erasable programmable read-only memory (EPROM), electrically erasable programmable read-only memory (EEPROM), field-programmable gate arrays (FPGAs), flash memory devices, and magnetic disks such as internal hard disks and removable disk, magneto-optical disks, and CD-ROM and DVD-ROM disks.

1. A computer-implemented system for life navigation and digital skills training operable across multiple device types and interaction modalities, comprising: a navigator engine executed by one or more hardware processors and including: (a) a user profile store, comprising a non-transitory computer readable medium, configured to store information for a plurality of users; (b) a tenant configuration store, comprising a non-transitory computer readable medium, configured to store branding information and module configurations for a plurality of organizational tenants; (c) a module registry, comprising a non-transitory computer readable medium, storing definitions of a plurality of life assistance modules; (d) an inference engine configured to receive interaction telemetry from client devices associated with the plurality of users and to generate one or more skill inferences based on the interaction telemetry, wherein the inference engine may employ artificial intelligence (AI), machine learning, rule-based logic, decision trees, or combinations thereof, and wherein the inference engine is further configured to identify memory-anchored navigation preferences by analyzing user interaction patterns with interface elements associated with familiar people, routines, and temporal anchors; (e) a dynamic user interface orchestration engine configured to automatically change a user interface for a given user based at least in part on the one or more skill inferences and on a role, tenant, and module context associated with the given user; and (f) a digital skills training and confidence system (DSTCS) overlay engine configured to provide task-based training flows within the user interface and to control access to features, modules, and interface elements based on user skill progression, wherein the dynamic user interface orchestration engine is further configured to: (i) detect touch input characteristics selected from the group comprising finger-based touches, nail-based taps, shaky or unstable touch patterns, and touch contact area, and adapt at least one layout, control size, navigation path, touch target spacing, snap-to-target behavior, dwell time threshold, or interaction modality of the user interface in response to the detected touch input characteristics; (ii) cause at least one life assistance module from the module registry to be unlocked for the given user based on completion of one or more DSTCS training flows; (iii) automatically re-enable guidance, assistance, or training elements when subsequent interaction telemetry indicates the given user is experiencing difficulty with previously mastered tasks; and (iv) provide emotional reassurance interface responses comprising supportive, confidence-building feedback messages tailored to user context, skill level, and interaction patterns to reduce anxiety and maintain user engagement during training and operation.

2. The system of claim 1, wherein the interaction telemetry comprises data from any digital interaction including: touch coordinates, touch contact area, tap dwell time, gesture trajectories, voice commands, gaze tracking, spatial gestures, navigation events, task completion events, error rates, hesitation patterns, interactions with memory-anchored navigation elements comprising photos of familiar people and routine-based temporal markers, and at least one contextual attribute selected from the group consisting of time-of-day, active module set, device form factor, interaction modality, and tenant identity.

3. The system of claim 1, wherein the AI inference engine is configured to classify the given user into at least one digital skill level, and wherein the dynamic user interface orchestration engine is configured to: (a) provide a simplified, stepwise user interface for a first skill level; and (b) provide a more complex, multi-module dashboard user interface for a second, higher skill level.

4. The system of claim 1, wherein the DSTCS overlay engine is configured to implement at least a Level 1 foundational training mode comprising guided exercises for basic digital interactions across any interaction modality selected from the group comprising touch, voice, gesture, or gaze-based inputs, and a Level 2 task-oriented training mode comprising guided workflows for digital tasks selected from the group comprising: (a) sending a text message; (b) opening a link contained in a message; (c) scanning a quick response (QR) code; and (d) joining a video meeting.

5. The system of claim 1, further comprising a rewards and progression engine configured to: (a) maintain a skills profile for the given user; (b) record completions of the one or more DSTCS training flows using any interaction modality; (c) based on the completions, unlock at least one of: (i) an additional life assistance module; (ii) a user interface theme; (iii) a badge or achievement indicator; (iv) access to advanced features or settings; (v) personalization options; and (vi) emotional reassurance interface responses that provide supportive, confidence-building feedback tailored to the user's context and progress; and (d) provide a culminating assembly experience wherein the given user, after progressing through training and achieving milestones, reaches a final stage where the user actively builds and personalizes their own life navigator by selecting and arranging modules in a guided, intentional assembly process that serves as a graduation milestone.

6. The system of claim 1, wherein the dynamic user interface orchestration engine is further configured to detect touch input characteristics including finger-based touches, nail-based taps, and shaky or unstable touch patterns by analyzing touch contact area, pressure, stability, and trajectory, and to adjust a size and spacing of interactive targets, to enable snap-to-target behavior, to adjust dwell time thresholds, to provide haptic or audio feedback, or to alter an interaction modality among touch, voice, gesture, gaze, or input based on the detected touch input characteristics.

7. A computer-implemented method for operating a life navigator platform with integrated digital skills training across multiple device types and interaction modalities, the method comprising: receiving, from a client device associated with a user, interaction telemetry representing any digital interaction including touch inputs, voice commands, gesture inputs, gaze tracking, navigation events, and task outcomes; determining, by an inference engine employing artificial intelligence, machine learning, rule-based logic, decision trees, or combinations thereof, at least one digital skill level and at least one motor stability characteristic for the user based on the interaction telemetry; selecting, by a dynamic user interface orchestration engine, a user interface configuration for the user based on the at least one digital skill level and on a role and tenant context, wherein the user interface configuration includes memory-anchored navigation elements comprising visual representations of familiar people and routine-based temporal markers; rendering, at the client device, the selected user interface configuration; providing, by a digital skills training and confidence system overlay, at least one training flow that guides the user through a multi-step task comprising at least one of sending a text message, opening a link, scanning a QR code, or joining a video meeting; providing emotional reassurance interface responses during the training flow comprising supportive feedback messages tailored to user context and progress; monitoring, during the training flow, touches indicative of shaky-hand or nail-tap interactions; dynamically adjusting at least one element of the user interface in response to the touches indicative of shaky-hand or nail-tap interactions; and upon detecting completion of the training flow, updating a skills profile of the user and unlocking at least one life navigator module or feature.

8. The method of claim 7, further comprising: logging a plurality of training completions over time; and transitioning the user from a first interface configuration with stepwise prompts to a second interface configuration with fewer prompts based on the logged training completions.

9. The method of claim 7, wherein dynamically adjusting the at least one element of the user interface comprises at least one of: increasing a touch target size, increasing spacing between interactive controls, increasing a dwell time threshold for recognizing a tap, or presenting a confirmation overlay with enlarged controls.

10. The method of claim 7, wherein providing the at least one training flow comprises overlaying visual highlights on controls within an existing life assistance module, rather than switching to a separate training application.

11. A method for operating a life navigator platform with integrated digital skills training, comprising: executing a navigator engine on one or more hardware processors to maintain a user profile store and a tenant configuration store; storing module definitions in a module registry, comprising a non-transitory computer readable medium; receiving interaction telemetry from client devices associated with users, selected from the group comprising touch coordinates, contact area, tap dwell time, gesture trajectories, navigation events, and contextual attributes such as time-of-day and tenant identity; determining digital skill levels and motor stability characteristics using an AI inference engine based on the interaction telemetry; dynamically selecting a user interface configuration using a dynamic user interface orchestration engine, wherein the adaptation is based on skill inferences, role, and tenant context; and implementing a digital skills training and confidence system overlay that includes foundational training for basic interactions and task-oriented training for actions such as sending text messages, opening links, and joining video meetings; and maintaining a skills profile for users, recording training completions, and unlocking life navigator modules or interface elements based on training progress, wherein shaky-hand or nail-tap interactions are detected and the interface is adjusted accordingly.

12. The method of claim 11, further comprising receiving interaction telemetry that includes touch coordinates, contact area, tap dwell time, gesture trajectories, navigation events, and contextual attributes such as time-of-day and tenant identity.

13. The method of claim 11, wherein the AI inference engine classifies users into digital skill levels, and the UI orchestration engine provides a simplified interface for lower skill levels and a complex dashboard for higher skill levels.

14. The method of claim 11, further comprising implementing a digital skills training and confidence system overlay that includes foundational training for basic interactions and task-oriented training for actions such as sending text messages and joining video meetings.

15. The method of claim 11, further comprising maintaining a skills profile for users, recording training completions, and unlocking life assistance modules, user interface themes, or badges based on training progress.

16. The method of claim 11, wherein the UI orchestration engine adjusts touch target size, spacing, and interaction modality based on detected shaky-hand or nail-tap patterns.

17. (canceled)

18. (canceled)

19. (canceled)

20. (canceled)
